(19) United States
(12) Patent Application Publication
(10) Pub. No.: US 2008/0078941 A1
(43) Pub. Date: Apr. 3, 2008

(54) Inspection systems and methods

(76) Inventor: Francis Goodwin, Halfmoon, NY (US)

Correspondence Address: SLATER & MATSIL LLP, 17950 PRESTON ROAD, SUITE 1000, DALLAS, TX, 75252, US

(21) Appl. No.: 11/541,169

(22) Filed: Sep. 29, 2006

(51) Int. Cl. G01J 1/42

(52) U.S. Cl. 250/372

(57) ABSTRACT

Inspection systems and methods are disclosed. A preferred embodiment comprises an inspection system including a support for a reticle, a microscope including a lens system and at least one other component, and at least one device adapted to provide feedback regarding a distance between the support for the reticle and the lens system or the at least one other component of the microscope.

### TECHNICAL FIELD

The present invention relates generally to the fabrication of semiconductor devices, and more particularly to inspection systems and methods for reticles used to pattern material layers of semiconductor devices.

### BACKGROUND

Generally, semiconductor devices are used in a variety of electronic applications, such as computers, cellular phones, personal computing devices, and many other applications. Home, industrial, and automotive devices that in the past comprised only mechanical components now have electronic parts that require semiconductor devices, for example.

Semiconductor devices are manufactured by depositing many different types of material layers over a semiconductor workpiece, wafer, or substrate, and patterning the various material layers using lithography. The material layers typically comprise thin films of conductive, semiconductive, and insulating materials that are patterned and etched to form integrated circuits (ICs). There may be a plurality of transistors, memory devices, switches, conductive lines, diodes, capacitors, logic circuits, and other electronic components formed on a single die or chip, for example.

Optical photolithography involves projecting or transmitting light through a pattern comprised of optically opaque or translucent areas and optically clear or transparent areas on a mask or reticle. For many years in the semiconductor industry, optical lithography techniques such as contact printing, proximity printing, and projection printing have been used to pattern material layers of integrated circuits. Lens projection systems and transmission lithography masks are used for patterning, wherein light is passed through the lithography mask to impinge upon a photosensitive material layer disposed on semiconductor wafer or workpiece. After development, the photosensitive material layer is then used as a mask to pattern an underlying material layer. In some lithography systems, such as extreme ultraviolet (EUV) lithography systems, reflective lenses and masks are used to pattern a photosensitive material layer disposed on a substrate, for example.

In EUV lithography, the EUV lithography masks or reticles used to pattern material layers of semiconductor devices need to be inspected occasionally. However, in recent EUV metrology systems, in order to inspect an EUV lithography reticle, the reticle must be placed very close to an EUV reticle microscope, which is used to inspect the EUV lithography reticle for defects. In some EUV reticle microscopes, the optical lens system comprises an objective lens that must be placed very close to the reticle in order to inspect it, for example. There is a risk that the EUV lithography reticle may be placed too close to the EUV reticle microscope by the automatic handlers used to move the EUV lithography reticle into position for inspection, resulting in the EUV lithography reticle impacting or making contact with the objective lens of the EUV reticle microscope.

Some EUV lithography reticles are expensive, costing many thousands of dollars each, and the reticles may take several months to replace if damaged. Thus, if an EUV lithography reticle is damaged from impacting the objective lens of the EUV reticle microscope, a time delay in semiconductor device production and a high expense is incurred. Furthermore, the objective lens of the EUV reticle microscope may be damaged if it makes contact with the EUV lithography reticle being inspected, resulting in further costs and delays.

Thus, what are needed in the art are improved inspection systems and methods for lithography reticles.

### SUMMARY OF THE INVENTION

These and other problems are generally solved or circumvented, and technical advantages are generally achieved, by preferred embodiments of the present invention, which provide inspection systems and methods for lithography reticles.

In accordance with a preferred embodiment of the present invention, an inspection system includes a support for a reticle, a microscope including a lens system and at least one other component, and at least one device adapted to provide feedback regarding a distance between the support for the reticle and the lens system or the at least one other component of the microscope.

The foregoing has outlined rather broadly the features and technical advantages of embodiments of the present invention in order that the detailed description of the invention that follows may be better understood. Additional features and advantages of embodiments of the invention will be described hereinafter, which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 shows an inspection system for a lithography reticle that includes a focus artifact disposed on a support for the reticle in accordance with a preferred embodiment of the present invention;

FIG. 2 shows a more detailed view of an area proximate a top surface of the reticle and an objective lens of a lens system of the inspection system shown in FIG. 1;

FIG. 3 shows a view of an EUV lithography reticle being loaded onto a support for a reticle of an inspection system through a load lock by a handler in accordance with an embodiment of the present invention;

FIG. 4 is a top view of a focus artifact disposed on the support for the reticle shown in FIG. 3;

FIG. 5 shows the EUV lithography reticle of FIG. 3 after the support for the reticle is moved so that the focus artifact is disposed under the lens system of the EUV reticle microscope of the inspection system;

FIG. 6 shows the EUV lithography reticle of FIG. 5 after the support for the reticle is moved upwardly towards the EUV reticle microscope so that the focus artifact is disposed at a working distance of an objective lens of the lens system of the EUV reticle microscope;

FIG. 7 shows the EUV lithography reticle of FIG. 6 after the support for the reticle is moved laterally at the working distance so that the EUV lithography reticle may be more finely focused and inspected by the EUV reticle microscope;

FIG. 8 shows an inspection system in accordance with another embodiment of the present invention, wherein a plurality of sensors are disposed on a support for a reticle or are disposed proximate an objective lens of a EUV reticle microscope, for maintaining focus and leveling control;

FIG. 9 shows a top view of a support for a reticle in accordance with a preferred embodiment of the present invention, wherein at least three sensors are disposed on corners of the support for the reticle; and

FIG. 10 shows an inspection system in accordance with another preferred embodiment of the present invention, wherein the inspection system includes a focus artifact as shown in FIGS. 1 through 7, and further includes a plurality of sensors as shown in FIGS. 8 and 9.

Corresponding numerals and symbols in the different figures generally refer to corresponding parts unless otherwise indicated. The figures are drawn to clearly illustrate the relevant aspects of the preferred embodiments and are not necessarily drawn to scale.

### DETAILED DESCRIPTION OF ILLUSTRATIVE EMBODIMENTS

The making and using of the presently preferred embodiments are discussed in detail below. It should be appreciated, however, that embodiments of the present invention provide many applicable inventive concepts that can be embodied in a wide variety of specific contexts. The specific embodiments discussed are merely illustrative of specific ways to make and use the invention, and do not limit the scope of the invention.

Some recent lithography techniques involve the use of a decreased wavelength of the light source and lower numerical apertures, such as in EUV lithography. EUV lithography reticles are typically examined or inspected using an EUV reticle microscope. In order to avoid requiring a large objective lens in the lens systems of the EUV reticle microscope, the lens system of the EUV reticle microscope is brought down lower towards the reticle during inspection. For example, the working distance between a reticle and an objective lens of an EUV reticle microscope may be about 2 mm. Thus, there is an increased risk of an impact between the objective lens and the reticle, which can result in damage to both.

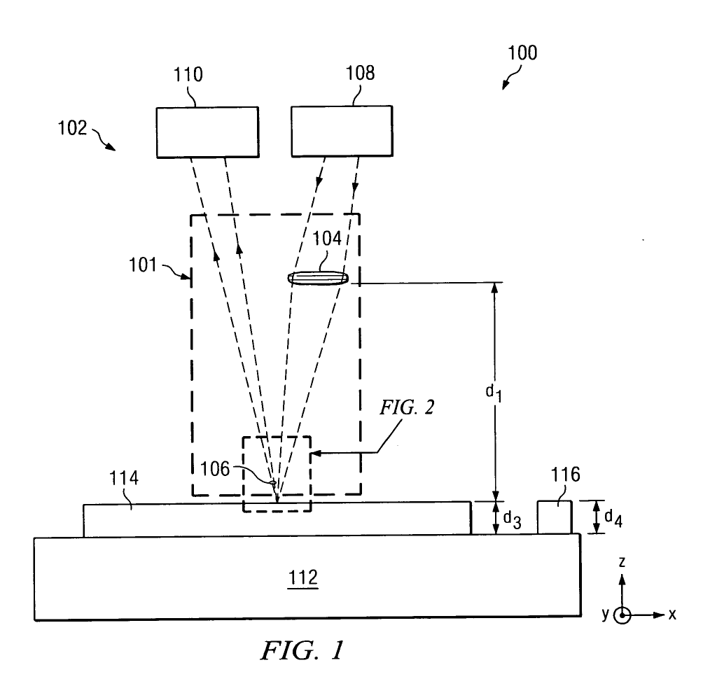

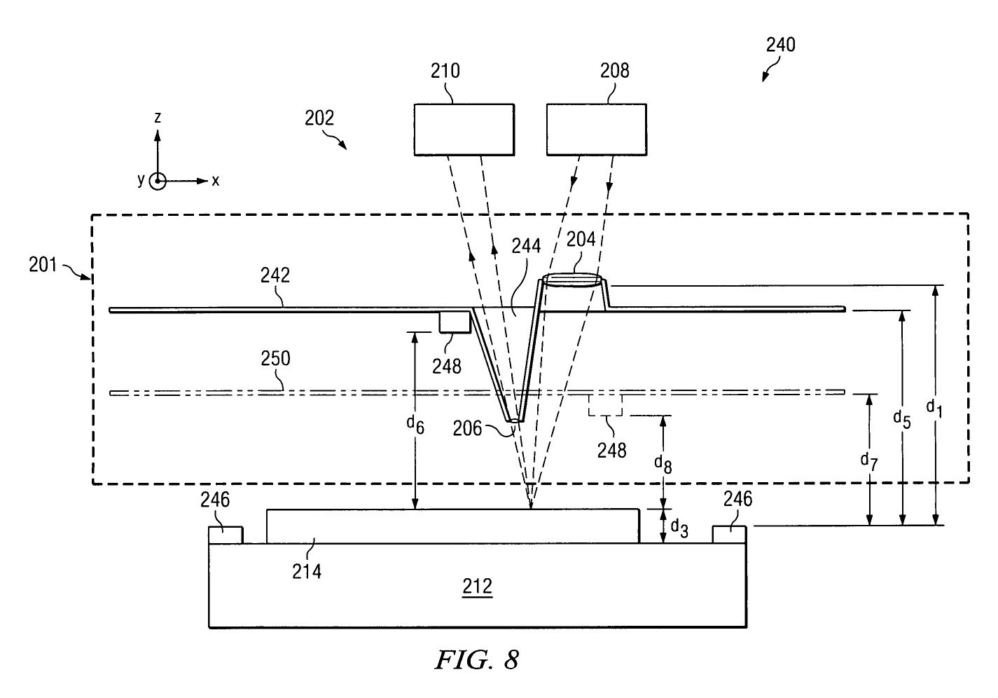

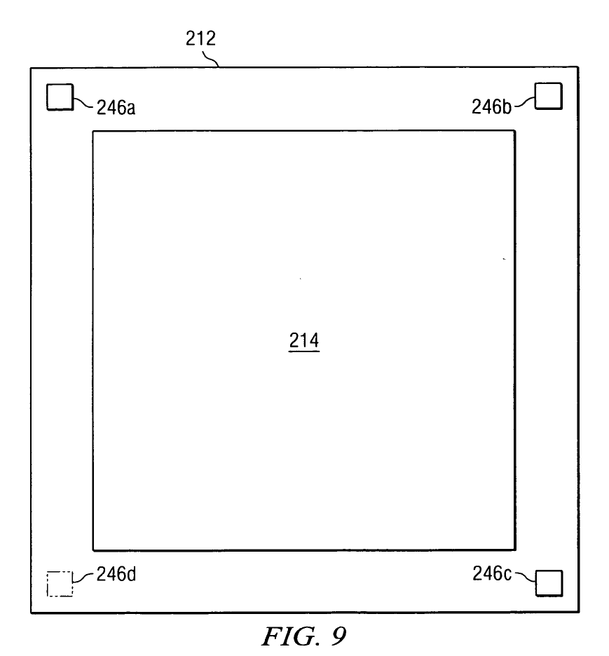

The inspection systems of embodiments of the present invention include at least one device adapted to provide feedback regarding a distance between a support for a lithography reticle and a lens system or another component, such as a lens support or other component, of a microscope, thus providing the system with distance information that enables the prevention of an impact of the lithography reticle with the lens system. In FIGS. 1 through 7, the at least one device comprises at least one focus artifact. In FIGS. 8 and 9, the at least one device comprises a plurality of sensors, to be described further herein.

The present invention will be described with respect to preferred embodiments in a specific context, namely used for inspection of EUV lithography reticles used in EUV lithography systems. Embodiments of the invention may also be used to inspect reticles used in other types of lithography systems used to pattern material layers of semiconductor devices, to be described further herein. Embodiments of the present invention have useful application in EUV or other types of production or test lithography reticles, for example.

Referred first to FIG. 1, an inspection system 100 for an EUV lithography reticle 114 is shown in accordance with a preferred embodiment of the present invention. In the inspection system 100 shown, an EUV reticle microscope 102 is used to inspect an EUV lithography reticle 114 placed on a support 112 for the reticle 114. The support 112 for the reticle 114 may comprise a stage or other support structure that is adapted to move in the x, y, and z directions, e.g., using one or more motors (not shown). The EUV reticle microscope 102 is typically stationary and comprises a lens system 101 which includes an objective lens 106 proximate the support 112 for the reticle 114 and a condenser lens 104 opposite the objective lens 106. The lens system 101 may also comprise a lens support plate, to be described further herein, for example. The condenser lens 104 is preferably positioned away from the reticle 114 by a greater distance d₁ than the objective lens 106 is spaced apart from the reticle 114. For example, the condenser lens 104 may be spaced apart from the reticle 114 by a distance d₁ of about one foot or more.

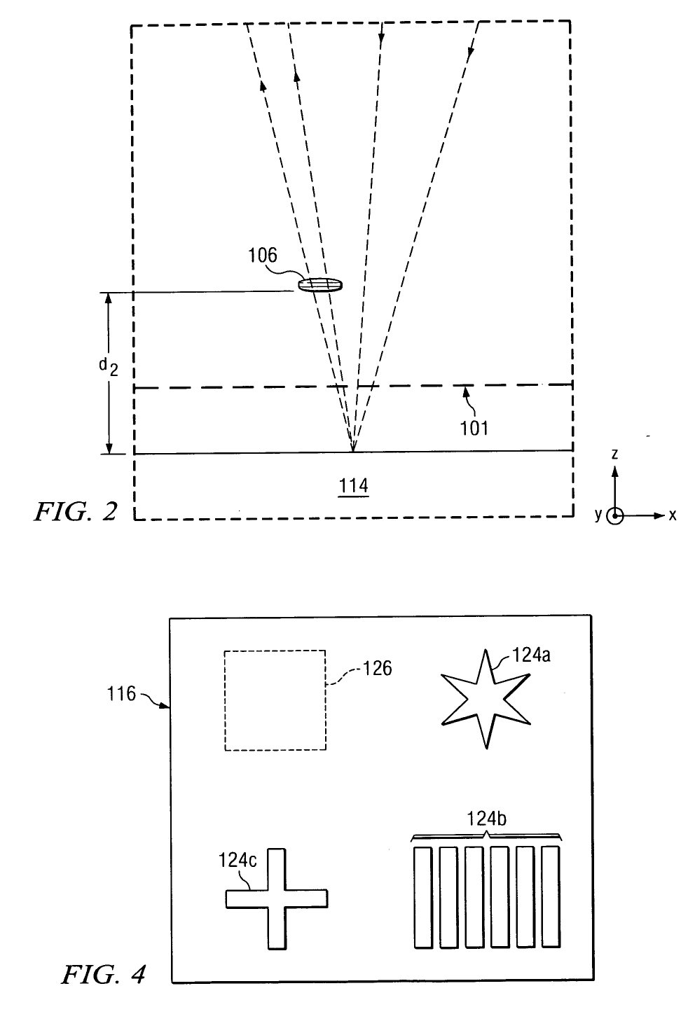

FIG. 2 shows a more detailed view of an area proximate a top surface of the reticle 114 and the objective lens 106 of the lens system 101 of the EUV reticle microscope of the inspection system 100 shown in FIG. 1. The objective lens 106 is preferably positioned closer to the reticle 114 than the condenser lens 104. For example, distance d₂ between the reticle 114 the objective lens 106 may comprise about 2 mm or less, although the distance d₂ may alternatively comprise other dimensions. The distance d₂ may comprise a few centimeters, in some embodiments, for example. The objective lens 106 and the condenser lens 104 are preferably spaced apart within the lens system 101 by about one foot or more, for example. The distance d₂ is also referred to herein as a working distance between the objective lens 106 of the EUV reticle microscope 102 and the reticle 114, for example.

Referring again to FIG. 1, the EUV reticle microscope 102 includes an EUV light source 108 proximate the lens system 101. The EUV light source 108 is also referred to herein as an energy source, for example. The energy source 108 is preferably adapted to generate photons having a wavelength of about 13.5 nm, in some embodiments, for example, although other wavelengths of energy may also be used.

The lens system 101 comprised of the condenser lens 104 and the objective lens 106 is disposed between the EUV light source 108 and the support 112 for the EUV lithography reticle 114. The EUV reticle microscope 102 also includes an energy collector 110 proximate the lens system 101, e.g., which may be proximate the EUV light source 108. The EUV light source 108 is adapted to illuminated the reticle 114 disposed on the support 112 with EUV light, and the energy collector 110 comprises a camera, charge coupled device (CCD), or other device adapted to capture the EUV light or energy from the EUV light source 108 that is reflected off of the EUV lithography reticle 114.

The inspection system 100 includes at least one focus artifact 116 disposed on the support 112 for the EUV lithography reticle 114, as shown. One focus artifact 116 may be disposed on the support 112 for the reticle 114, as shown, or a plurality of focus artifacts 116 may be disposed on the support 112 for the reticle 114, for example. The focus artifact 116 preferably comprises substantially the same thickness as the EUV lithography reticle 114, in some embodiments, for example. The EUV lithography reticle 114 may comprise a dimension d₃, and the focus artifact 116 may comprise a dimension d₄, wherein dimension d₄ is substantially equal to dimension d₃, for example. The EUV lithography reticle 114 and the focus artifact 116 may comprise a thickness or dimension d₃ and d₄, respectively, of about 0.625 mils, as an example, although alternatively, the dimensions d₃ and d₄ of the reticle 114 and the focus artifact 116 may comprise other dimensions.

The focus artifact 116 may be permanently or removeably affixed to the support 112 for the reticle 114. For example, the focus artifact 116 may be glued or fastened to the support 112 with screws or other attachment means, not shown.

In other embodiments, the EUV lithography reticle 114 preferably comprises a dimension d₃, and the focus artifact 116 preferably comprises a dimension d₄ that is smaller than dimension d₃ of the reticle 114 by a predetermined amount, such as by a few mm, as an example. The dimension d₄ may alternatively be smaller than dimension d₃ by other values or predetermined amounts, for example.

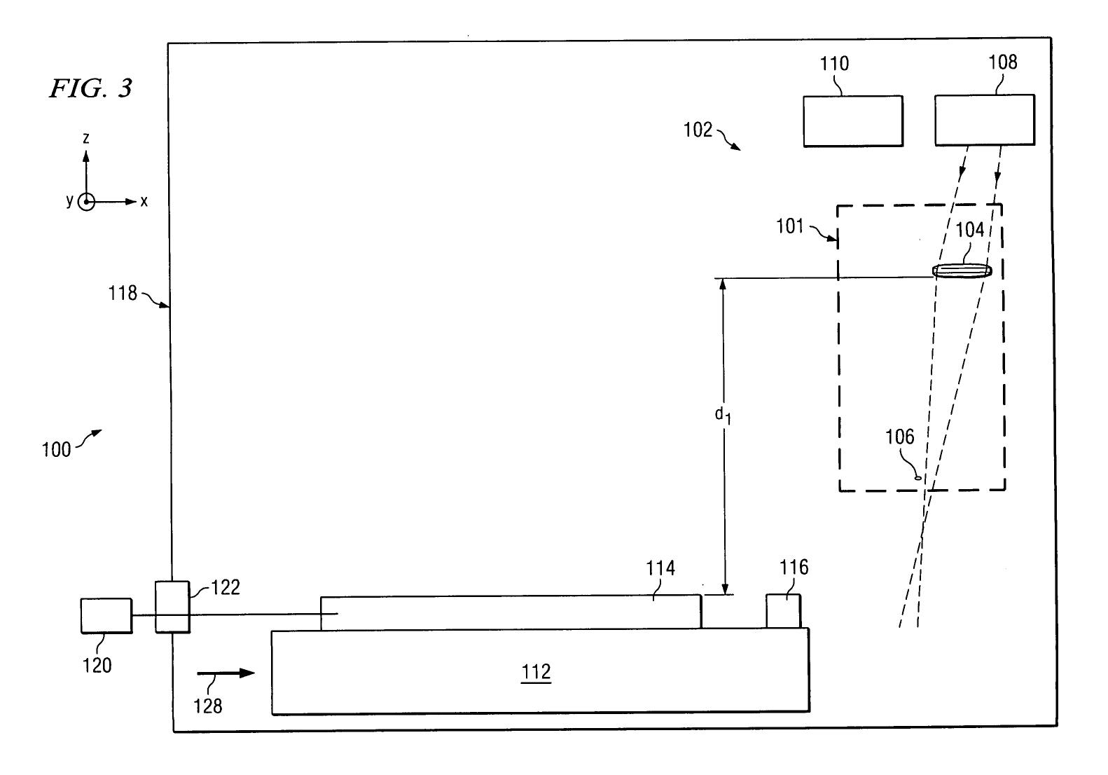

FIGS. 3, 5, 6, and 7 illustrate exemplary sequential steps that may be used to utilize the novel inspection systems of embodiments of the present invention. FIG. 3 shows a view of an EUV lithography reticle 114 being loaded (e.g., indicated by movement 128) onto a support 112 for the reticle 114 having a focus artifact 116 disposed thereon through a load lock 122 of a chamber 118 by a handler 120 in accordance with an embodiment of the present invention. The EUV reticle microscope 102 and the stage 112 may be contained within a chamber 118, for example, that is pressurized and/or contains a vacuum, for example. The handler 120 picks up the reticle 114 and places the reticle 114 on the support 112 through the load lock 122, as shown.

The reticle 114 preferably comprises an EUV lithography reticle in some embodiments, and preferably comprises one or more reflective materials in some embodiments, such as a Bragg reflection mirror, for example. Alternatively, the reticle 114 may comprise transmissive materials, alternating phase shifting materials, attenuating materials, or combinations thereof with one or more reflective materials, for example. The reticle 114 may comprise a lithography mask comprising opaque or light-absorbing regions and transparent or light-reflecting regions, for example. Embodiments of the present invention may also be implemented in inspection methods and systems for alternating phase-shift masks, combinations thereof with masks comprising opaque or light-absorbing regions and transparent or light-reflecting regions, and other types of lithography masks, for example.

The reticle 114 may comprise a substantially transparent material comprising quartz glass having a thickness of about ¼″, with an opaque material such as chromium, which is opaque, having a thickness of about 30 nm bonded to the quartz glass. Alternatively, reticle 114 may comprise about 70 nm of a translucent material such as molybdenum silicon (MoSi), or a bilayer of tantalum and silicon dioxide (Ta/SiO₂). The reticle 114 may also be comprised of multiple layers of silicon and molybdenum that form a reflecting surface and may include an absorber material of tantalum nitride (TaN), for example. Alternatively, other materials and dimensions may also be used for the transparent or light-reflecting material and the opaque or light-absorbing material of the reticle 114 described herein, for example.

The reticle 114 may comprise a substantially square substrate, and may comprise a square having sides of about six inches, for example, although alternatively, the reticle 114 may comprise other shapes and sizes.

The focus artifact 116 may comprise similar or the same materials as mentioned for the reticle 114, for example. FIG. 4 shows a top view of the focus artifact 116 shown in FIG. 3. The focus artifact 116 may comprise a square substrate having sides of about 2 mm, for example, although alternatively, the focus artifact 116 may comprise other shapes and sizes.

The focus artifact 116 preferably comprises at least one focus pattern 124a, 124b, and 124c disposed thereon. For example, the at least one focus pattern 124a, 124b, and 124c may comprise the shape of a star 124a, a grating 124b, a cross 124c, or alternatively, the at least one focus pattern 124a, 124b, and 134c may comprise other shapes and features. The grating 124b may comprise a line and space pattern having a pitch of about 100 nm, as an example, although other sizes and shapes of gratings may also be used. The focus artifact 116 may be smaller than the reticle 114, for example. The focus artifact 116 may comprise dozens or hundreds of focus patterns 124a, 124b, and 124c formed thereon, for example, not shown.

In some embodiments, the focus artifact 116 comprises at least one region 126 that does not comprise a focus pattern 124a, 124b, and 124c disposed thereon; e.g., the region 126 comprises a blank region, for example. The focus artifact 116 may comprise dozens or hundreds of regions or areas 126 disposed thereon, for example, not shown. In other embodiments, the focus artifact 116 comprises at least one region comprising at least one focus pattern 124a, 124b, and 124c disposed thereon, and also comprises at least one region 126 that does not comprise a focus pattern disposed thereon, as another example.

The focus patterns 124a, 124b, and 124c and the region 126 preferably comprise dimensions that are substantially equal to or smaller than a spot size of the microscope 102. For example, in an EUV reticle microscope 102, the spot size may be about 14 μm.

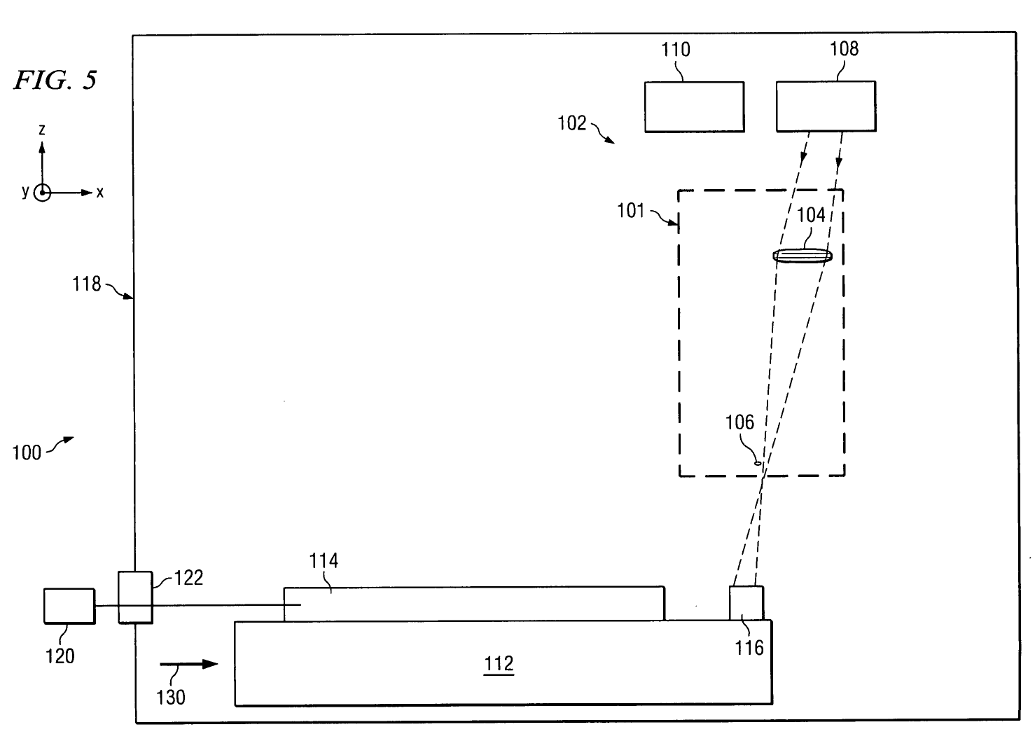

Next, with the support 112 for the reticle 114 spaced apart from the objective lens 106 of the lens system 101 of the microscope by an amount adequate to ensure that the reticle 114 will not inadvertently impact the objective lens 106 during the movement of the support 112, such as several cm or other dimensions greater than the working distance, the support 112 for the reticle 114 is moved (e.g., indicated by movement 130) to position the focus artifact 116 on the support 112 beneath the EUV reticle microscope 102, as shown in FIG. 5. FIG. 5 shows the inspection system 100 of FIG. 3 after the support 112 for the reticle 114 is moved so that the focus artifact 116 is disposed under the lens system 101 of the EUV reticle microscope 102, for example.

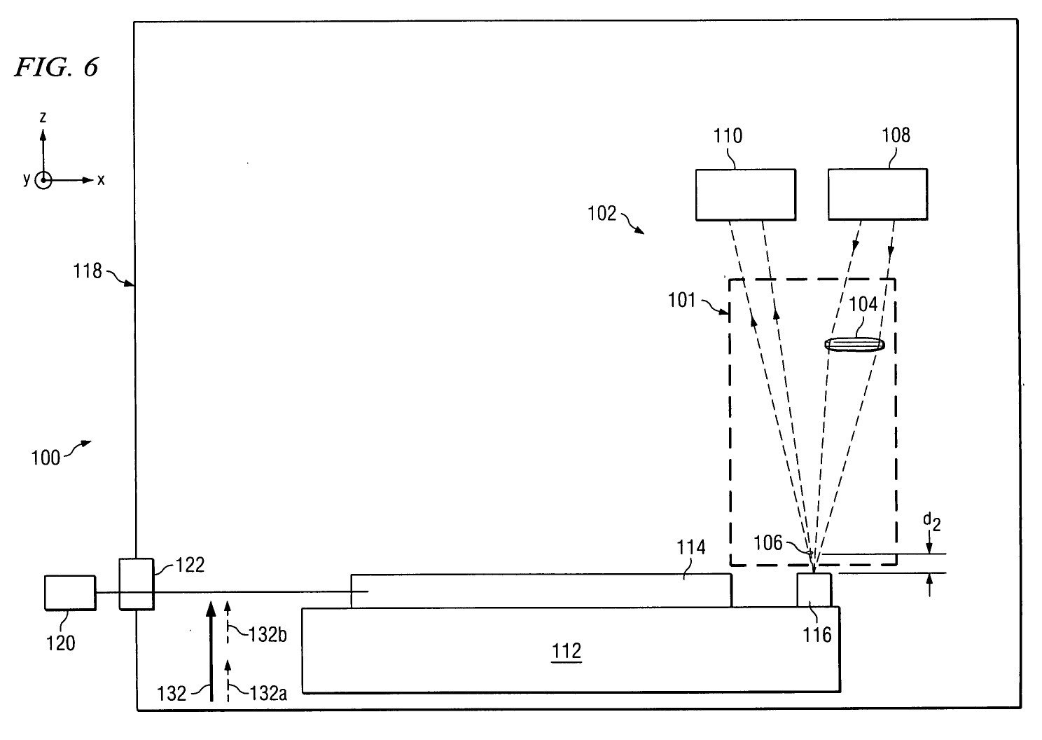

Next, the support 112 is moved upwards to position the focus artifact 116 closer to the EUV reticle microscope 102, e.g., to the working distance d₂ or close to the working distance d₂ of the inspection system 100. FIG. 6 shows the inspection system 100 of FIG. 5 after the support 112 for the reticle 114 is moved upwardly (e.g., indicated by movement 132) towards the EUV reticle microscope 102 so that the focus artifact 116 is disposed at the working distance d₂ away from the objective lens 106 of the lens system of the EUV reticle microscope 102, for example. The total amount of the upward movement 132 may be about 100 to 120 mm, for example, although the amount of upward movement 132 may also comprise other dimensions. The working distance d₂ comprises a distance at which the patterns 124a, 124b, and 124c can be focused by the lens system 101, e.g., by the objective lens 106, for example.

The EUV reticle microscope 102 illuminates EUV light or other energy from the EUV light source 108, possibly using annular illumination, as an example, although other types of illumination may also be used, through the lens system 101 comprising the condenser lens 106 and the objective lens 104, to focus the EUV light on the focus artifact 116, as shown. The EUV light is reflected off of the focus artifact 116 through the lens system 101 towards the energy collector 110 or camera that absorbs the EUV light. The camera 110 is used to determine if the pattern 124a, 124b, or 124c of the focus artifact 116 is in focus, and the support 112 for the reticle 114 is moved in an upward direction, indicated by upward movement 132, until the pattern 124a, 124b, or 124c on the focus artifact 116 is in focus. The camera 110 captures the image of the pattern 124a, 124b, or 124c of the focus artifact 116, or the image of the EUV light source 108 (e.g., the shape of the beam), if a region 126 of the focus artifact 116 is used for focusing, for example.

The focus artifact 116 is used as a device for providing feedback regarding the distance between the support 112 for the reticle 114 (and also the focus artifact 116) and the lens system 101, in particular the objective lens 106 or at least one other component of the EUV reticle microscope 102, for example. The inspection system 100 may include a computer, software, an operator interface, and other hardware and systems (not shown) adapted to process and store the information collected by the energy collector or camera 110. The information collected by the energy collector 110 is used to control the movement and focusing of the EUV reticle microscope 102, for example.

In some embodiments, rather than focusing on a pattern 124a, 124b, or 124c of the focus artifact, an area not having a pattern disposed thereon, such as area 126 shown in FIG. 4, may be used as a guide for the vertical positioning of the support 112 for the reticle 114, for example. A beam of energy from the EUV light source 108 may be focused on the focus artifact 116, and the shape of the energy beam may be focused and captured by the energy collector 110, in this embodiment, for example.

In some embodiments, two or more speeds of movement 132 may be used to move the support 112 for the reticle 114 in the upward direction. For example, as shown in phantom in FIG. 6, a first speed 132a and then a second speed 132b are used to move the support 112 upwards towards the EUV reticle microscope 102. For example, in this embodiment, moving the support 112 for the reticle 114 closer to the lens system 101 comprises: first, moving the support 112 for the reticle 114 at a first speed 132a; and second, moving the support 112 for the reticle 114 at a second speed 132b, the first speed 132a being greater than the second speed 132b.

The first speed 132a may result in the support 112 being positioned a predetermined distance away from the objective lens 106, e.g., slightly greater than the working distance d₂, e.g., by a few mm or cm, as examples. The slower second speed 132b is then used for fine-tuning of the support 112 (e.g., the focus artifact 116 disposed on the support 112) so that a pattern 124a, 124b, or 124c comes into focus, e.g., as “viewed” by the camera 110.

In embodiments wherein the focus artifact 116 comprises a thickness that is thinner than the thickness of the reticle 114 by a predetermined amount, the movement 132 may comprise bringing the focus artifact 116, e.g., and the support 112 closer to the objective lens 106, and the fine tuning of the positioning of the support 112 may be performed later after the reticle 114 is moved into position beneath the EUV reticle microscope 102, for example. In these embodiments, the faster first speed 132a alone may be used for the closer positioning of the support 112 proximate the lens system 101 of the EUV reticle microscope 102, for example.

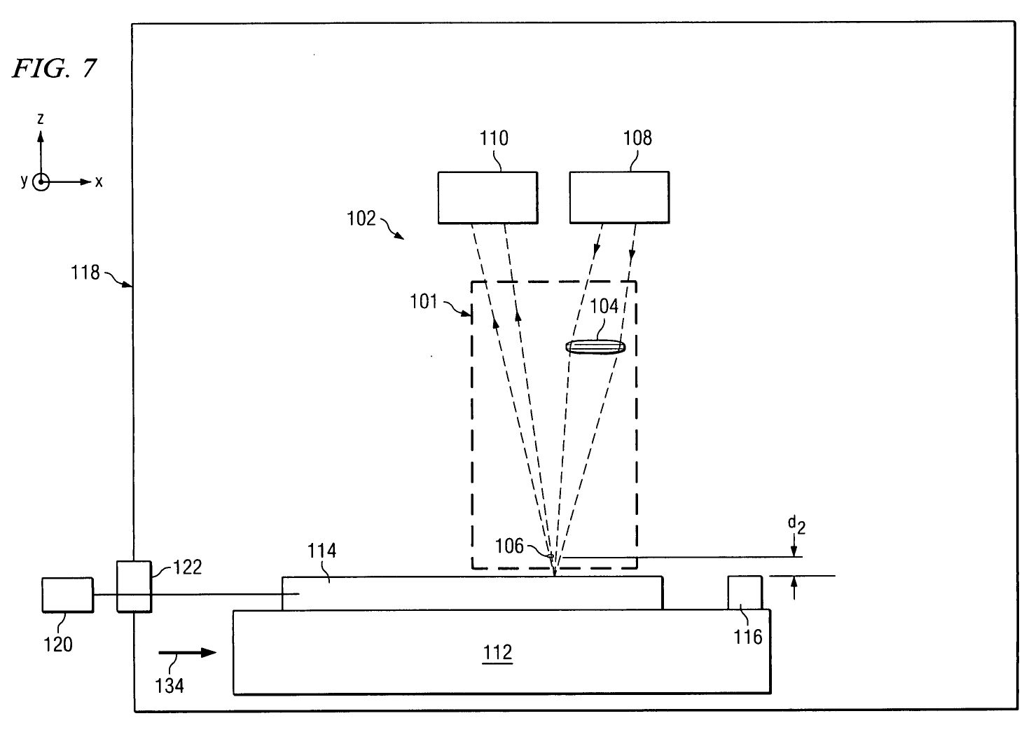

Next, after the support 112 is moved closer to the objective lens 106 using the focus artifact 116 for focusing or guidance, providing an indicia of the distance between the focus artifact 116 and the objective lens 106, as shown in FIG. 6, then the reticle 114 may be moved under the objective lens 106 for fine focusing and inspection of the reticle 112. For example, FIG. 7 shows the EUV lithography reticle 114 of FIG. 6 after the support 112 for the reticle 114 is moved laterally, indicated by movement 134, while maintaining the support 112 and reticle 114 vertical (z) position at the working distance d₂ or close to the working distance d₂, so that the EUV lithography reticle 114 may then be more finely focused and inspected by the EUV reticle microscope 102.

Advantageously, the working distance d₂ of the inspection system 100 has been established or set using the focus artifact 116 as shown in FIG. 6, and thus, the support 112 has been positioned vertically such that the reticle 114 will not make impact with the lens system 101 during the movement 134 to place the reticle 114 beneath the lens system 101, as shown in FIG. 7. In the embodiment shown in FIGS. 1 through 7, the focus artifact 116 advantageously comprises a sacrificial component used for positioning the support 112 for the reticle 114 at the desired distance (e.g., working distance d₂) or close to the desired distance away from the objective lens 106 of the EUV reticle microscope 102.

If the focus artifact 116 is inadvertently brought into direct contact with the objective lens 106 during movement 132 shown in FIG. 6, for example, a region of the focus artifact 116 may be damaged, e.g., a pattern 124a, 124b, or 124c or area 126 may be damaged. The damaged pattern 124a, 124b, or 124c or area 126 may selectively not be used for focusing in future use of the inspection system 100, for example, but rather, undamaged patterns 124a, 124b, or 124c or areas 126 may continue to be used for distance control in subsequent inspections, for example. The focus artifact 116 may also be replaced occasionally, as needed or on a periodic basis, as another example. Advantageously, because the focus artifact 116 is used for feedback regarding the distance between the focus artifact 116 and the EUV reticle microscope 102, if any contact of the focus artifact 116 with the objective lens 106 occurs, the focus artifact 116 is damaged rather than the reticle 114, according to this embodiment of the present invention.

Thus, the novel focus artifact 116 may be used as a reference for all reticles 114 inspected using the inspection system 100. The focus artifact 116 allows variable speeds of moving the support 112 closer to the lens system 101, to conserve time in the inspection process.

In some embodiments, an area 126 comprising a blank region (e.g., not having a pattern thereon) may be used to resolve the illumination spot of the condenser lens 104 of the lens system 101 for course focusing, for example, and then a pattern 124a, 124b, or 124c of the focus artifact 116 may be moved under the objective lens 106 for fine focusing, for example.

FIG. 8 shows an inspection system 240 in accordance with another embodiment of the present invention, wherein a plurality of sensors 246 and 248 are disposed on a support 212 for a reticle 214, or at least one sensor 248 is disposed proximate an objective lens 206 of a lens system of a EUV reticle microscope 202, or both, for maintaining focus and for leveling control. Note that like numerals are used in FIG. 8 as were used in the previous figures, and to avoid repetition, all of the elements are not described in detail again herein. Rather, similar materials and devices x01, x02, x04, x06, etc . . . are preferably used for the various elements shown as were described for the previous figures, where x=1 in FIGS. 1 through 7, and x=2 in FIG. 8.

In the embodiment shown in FIG. 8, rather than using a focus artifact as shown in FIGS. 1 through 7 as a device for providing feedback regarding a distance between the support for the reticle and the lens system of the microscope, the plurality of sensors 246 and 248 are used for distance feedback and also leveling control. The lens system 201 includes a lens mounting plate 242 upon which the condenser lens 204 and the objective lens 206 are mounted. The objective lens 206 may be mounted to the plate 242 by a cone-shaped or other type of support 244, as shown. The support 244 may comprise a piezoelectric stage having x, y, and z adjustments for leveling the objective lens 206, as an example. The objective lens 206 may be mounted below the plate 242 and the condenser lens 204 may be mounted above the plate 242, as shown, for example. Note that the lens system 101 of the inspection system 100 shown in FIGS. 1 through 7 may also include a lens mounting plate 242 (not shown in FIGS. 1 through 7).

Preferably, a plurality of sensors 246 are mounted to the support 212 for the reticle 214, as shown in a cross-sectional view in FIG. 8, and as shown in a top view in FIG. 9. More preferably, at least three sensors 246 are disposed on the support 212 for the reticle 214, as shown in FIG. 9 at 246a, 246b, and 246c, for example. The sensors 246a, 246b, and 246c are preferably disposed on the corners of the support 212 in some embodiments, although the sensors 246a, 246b, and 246c may alternatively be disposed in other locations of the support 212 for the reticle 214, for example. The support 212 may comprise the shape of a square, as shown, and the sensors 246a, 246b, and 246c may be formed at each corner of the square support 212, for example, as shown. Optionally, in some embodiments, a sensor 246a, 246b, 246c, and 246d (shown in phantom) may be mounted on each corner of the support 212 for the reticle 214, as shown in FIG. 9, for example. The sensors 246a, 246b, 246c, and 246d may comprise a thickness less than the thickness d₃ of the reticle 214, as shown in a cross-sectional view in FIG. 8, although alternatively, the sensors 246a, 246b, 246c, and 246d may comprise a larger thickness or the same thickness as the reticle 214, for example, not shown.

Each sensor 246a, 246b, 246c, and 246d is preferably adapted to determine a distance d₅ (see FIG. 8) between the sensor 246a, 246b, 246c, and 246d and the lens mounting plate 242. For example, the sensors 246a, 246b, 246c, and 246d may comprise capacitor sensors in some embodiments. The capacitor sensors are preferably adapted to measure a charge from an anode to a cathode, and the capacitance provides an indication of the distance between the anode and cathode. The sensors 246a, 246b, 246c, and 246d may comprise an anode or cathode, and a cathode or anode may be disposed onto the lens mounting plate 242, for example (or reference plate 250).

In other embodiments, the sensors 246a, 246b, 246c, and 246d may comprise optical sensors, as another example. Alternatively, the sensors 246a, 246b, 246c, and 246d may comprise other types of sensors adapted to provide distance information between the support 212 for the reticle 214 and the lens mounting plate 242 of the lens system 201, for example.

The distance d₅ between each of the sensors 246a, 246b, 246c, and 246d is measured and compared by the inspection system 240 during the movement of the support 212 for the reticle 214 beneath the lens system 201. If the distances d₅ between the sensors 246a, 246b, 246c, and 246d vary for each 246a, 246b, 246c, and 246d, then the support 212 is moved (e.g., by a handler such as handler 120 shown in the previous figures), e.g., in the x, y, and/or z direction until the distances d₅ between the sensors 246a, 246b, 246c, and 246d and the lens mounting plate 242 are substantially equal. Thus, the sensors 246a, 246b, 246c, and 246d disposed on the support 212 for the reticle 214 provide leveling information and feedback, and provide a means for leveling the support 212 with respect to the lens mounting plate 242 of the lens system. The distance information d₅ may be used to achieve parallel positioning of the support 212 for the reticle 214 with respect to the lens mounting plate 242, for example. The distance information d₅ may be processed by a computer of the inspection system 240, for example, not shown.

In some embodiments, the inspection system 240 preferably includes a sensor 248 mounted proximate the objective lens 206, as shown. The sensor 248 preferably comprises a capacitor sensor, an optical sensor, or other types of sensors, as examples. The sensor 248 is adapted to provide information regarding the distance d₆ between the sensor 248 and/or mounting plate 242 and a top surface of a reticle 214 mounted on the support 212 for the reticle 214, for example. The sensor 248 is adapted to measure the distance d₆, for example.

In some embodiments, for example, the inspection system 240 preferably includes a plurality of sensors 246 on the support 212 for the reticle 214 and also a sensor 248 proximate the objective lens 206 of the lens system, e.g., disposed on the lens mounting plate 242 proximate the objective lens 206, for example, as shown. The sensors 246 are used to level the support 214 with respect to the lens system 201 and sensor 248 is advantageously used as an additional distance d₆ measurement in these embodiments, for example. In some embodiments, the sensor 248 preferably comprises an optical sensor, for example.

In other embodiments, an additional reference plate 250 may be included in the inspection system 240 to retain the distance sensor 248, as shown in phantom in FIG. 8. The reference plate 250 may be coupled to the lens system 201, for example, and may be disposed below the objective lens 206, as shown. The reference plate 250 may be clamped or attached to the lens mounting plate 242 or other part of the lens system 201. The reference plate 250 may be spaced apart from the objective lens 206 by a predetermined amount, e.g., by a few mm or cm.

In these embodiments, the sensor 248 may be mounted to the reference plate 250, as shown in phantom. The sensors 246 in this embodiment may be adapted to provide distance information regarding the distance d₇ between the support 212 for the reticle 214 and the reference plate 250, for example, and the sensors 246 may be used for leveling (e.g., of the support 212 with respect to the reference plate 250; the support 212 is maintained parallel to the reference plate 250 by the inspection system 240). The sensor 248 may be adapted to provide distance information regarding the distance d₈ between the sensor 248 and the reticle 214 top surface, for example.

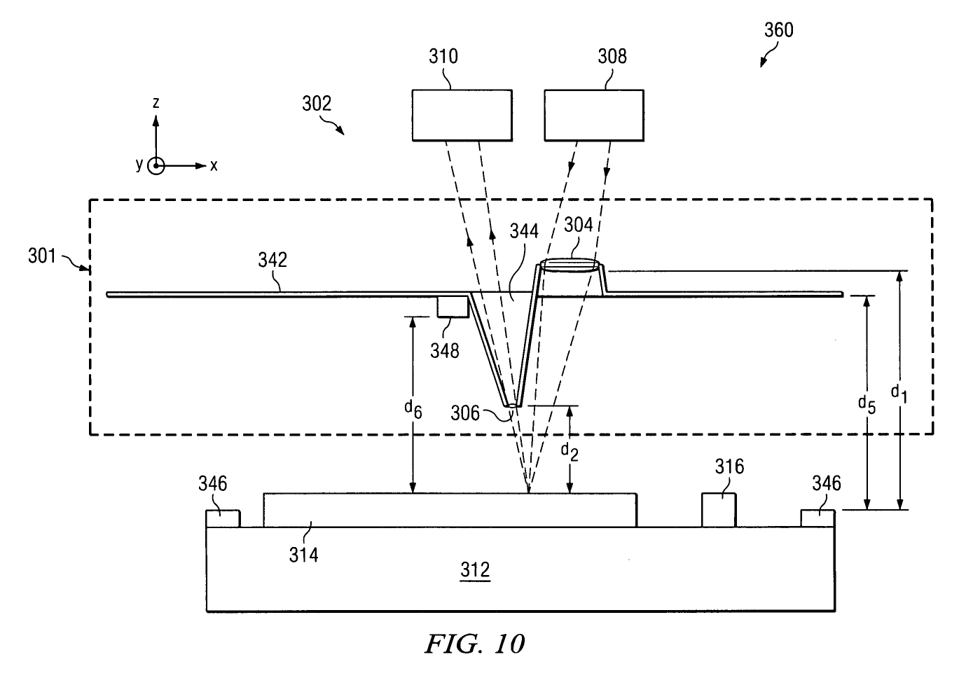

FIG. 10 shows an inspection system 360 in accordance with a preferred embodiment of the present invention, wherein the inspection system 360 includes a focus artifact 316 as shown in FIGS. 1 through 7, and further includes a plurality of sensors 246 and 248 as shown in FIGS. 8 and 9. Again, like numerals are used for the various elements in FIG. 10 that were used for the previous figures, and to avoid repetition, each reference number shown in FIG. 10 is not described again in detail herein. Advantageously, the focus artifact 316 may be used to position the support 312 for the reticle 314 at the working distance or close to the working distance, before the support 312 is positioned beneath the lens system 301. The sensors 346 may be used to leveling of the support 312 during movement beneath the lens system 301, and the sensor 348 may be used to ensure that the working distance d₂ is maintained. The novel devices (e.g., focus artifact 316, sensors 346, and sensor 348) of embodiments of the present invention prevent a collision of the objective lens 306 of the lens system 301 with the reticle 314 under inspection, advantageously, avoiding damage to the reticle 314.

Note that in FIG. 10, the optional reference plate is not shown. In some embodiments, the sensor 348 may be mounted on a reference plate coupled to the lens system 301, as shown in phantom in FIG. 8 (e.g., refer to sensor 248 mounted on reference plate 250).

Embodiments of the present invention also include methods of manufacturing semiconductor devices. For example, in accordance with a preferred embodiment of the present invention, a method of manufacturing a semiconductor device comprises providing an inspection system 100, 240, or 360 for a lithography reticle 114, 214, or 314, as shown in FIGS. 1, 8, and 10, respectively. The inspection system 100, 240, or 360 comprises at least one device adapted to provide feedback regarding a distance between a support 112, 212, or 312 for the lithography reticle 114, 214, or 314 and a lens system 101, 201, or 301 of the microscope 102, 202, or 302 of the inspection system 100, 240, or 360. The method includes disposing a lithography reticle 114, 214, or 314 on the support for the lithography reticle 114, 214, or 314 of the inspection system 100, 240, or 360, inspecting the lithography reticle 114, 214, or 314 using the inspection system 100, 240, or 360, and affecting a semiconductor device using the lithography reticle 114, 214, or 314.

The method of manufacturing the semiconductor device may include further comprising, after inspecting the lithography reticle 114, 214, or 314 using the inspection systems 100, 240, or 360 described herein: cleaning the lithography reticle 114, 214, or 314, replacing the lithography reticle 114, 214, or 314, altering the lithography reticle 114, 214, or 314, or altering a parameter of a lithography system used to affect the semiconductor device using the lithography reticle 114, 214, or 314, as examples.

Affecting the semiconductor device using the lithography reticle 114, 214, or 314 may comprise providing a workpiece, the workpiece including a material layer to be patterned and a layer of photosensitive material disposed over the material layer, and patterning the layer of photosensitive material using the lithography reticle. The layer of photosensitive material is developed, and then used as a mask to pattern the material layer, and the layer of photosensitive material is removed. The material layer of the workpiece may comprise a conductive material, an insulating material, a semiconductive material, or multiple layers or combinations thereof, as examples.

Embodiments of the present invention also include novel inspection methods using the inspection systems 100, 240, or 360 described herein. For example, in accordance with one embodiment, an inspection method preferably comprises providing an inspection system 100, 240, or 360 for a lithography reticle 114, 214, or 314, disposing a lithography reticle 114, 214, or 314 on the support 112, 212, or 312 for the lithography reticle 114, 214, or 314 of the inspection system 100, 240, or 360, and moving the support 112, 212, or 312 for the lithography reticle 114, 214, or 314 proximate the lens system 101, 201, or 301 while obtaining feedback regarding the distance between the support 112, 212, or 312 for the lithography reticle 114, 214, or 314 and the lens system 101, 201, or 301 of a microscope 102, 202, or 302 from at least one device 116, 246, 248, 316, 346, or 348. The inspection method may include inspecting the lithography reticle 114, 214, or 314 using the microscope 102, 202, or 302 by illuminating the lithography reticle 114, 214, or 314 using the energy source 108, 208 or 308, and analyzing energy collected by the energy collector 110, 210, or 310.

The at least one device 116, 246, 248, 316, 346, or 348 may comprise a plurality of first distance sensors 246 or 346 disposed on the support 112, 212, or 312 for the lithography reticle 114, 214, or 314 and a second distance sensor 248 or 348 proximate the lens system 101, 201, or 301, and the inspection methods may further comprise determining leveling information regarding the support 112, 212, or 312 for the lithography reticle 114, 214, or 314 relative to the lens system 101, 201, or 301 from the plurality of first distance sensors 246 or 346 and the second distance sensor 248 or 348 while moving the support 112, 212, or 312 for the lithography reticle 114, 214, or 314 proximate the lens system 101, 201, or 301, for example.

The inspection methods may further comprise altering the position of the support 112, 212, or 312 for the lithography reticle 114, 214, or 314 based on the leveling information received from the plurality of first distance sensors 246 or 248 and the second distance sensor 346 or 348.

In embodiments where the at least one device comprises at least one focus artifact 116 or 316 disposed on the support for the lithography reticle 114, 214, or 314, the inspection methods may further comprise, before inspecting the lithography reticle 114, 214, or 314 using the microscope 102, 202, or 302: positioning the support 112, 212, or 312 for the lithography reticle 114, 214, or 314 proximate yet spaced apart from the lens system 101, 201, or 301 by a first distance, moving the support 112, 212, or 312 for the lithography reticle 114, 214, or 314 to position the focus artifact 116 or 316 under an objective lens 106 or 306 of the lens system 101, 201, or 301 of the inspection system 100, 240, or 360 the first distance, moving the support 112, 212, or 312 for the lithography reticle 114, 214, or 314 closer to the lens system 101, 201, or 301, focusing the microscope 102, 202, or 302 on the focus artifact 116 or 316 at a second distance, the second distance being less than the first distance, and moving the support 112, 212, or 312 for the lithography reticle 114, 214, or 314 to position the lithography reticle 114, 214, or 314 under the objective lens 106 or 306 of the lens system 101, 201, or 301 of the inspection system 100, 240, or 360 at the second distance. Moving the support 112, 212, or 312 for the lithography reticle 114, 214, or 314 closer to the lens system 101, 201, or 301 may comprise: first, moving the support 112, 212, or 312 for the lithography reticle 114, 214, or 314 at a first speed 132a; and second, moving the support 112, 212, or 312 for the lithography reticle 114, 214, or 314 at a second speed 132b, the first speed 132a being greater than the second speed 132b, for example. Focusing the microscope 102, 202, or 302 at the first distance or the second distance may comprise focusing on a pattern 124a, 124b, or 124c or on a blank region 126 of the focus artifact 116 or 316.

Embodiments of the present invention also include semiconductor devices patterned using the lithography reticles 114, 214, or 314 inspected using the novel inspection systems 100, 240, or 360 and methods described herein, for example. Features of semiconductor devices patterned using the lithography reticles 114, 214, or 314 inspected using the inspection systems 100, 240, or 360 and methods described herein may comprise transistor gates, conductive lines, vias, capacitor plates, and other features, as examples. Embodiments of the present invention may be used to pattern features of memory devices, logic circuitry, and/or power circuitry, as examples, although other types of ICs may also be fabricated using the novel lithography reticles 114, 214, or 314 inspected using the novel inspection systems 100, 240, or 360 and methods described herein.

Embodiments of the present invention are particularly advantageous when used to inspect reticles 114, 214, or 314 used in lithography systems that utilize extreme ultraviolet (EUV) light, e.g., at a wavelength of about 13.5 nm, for example. Embodiments of the present invention are also advantageous when used to inspect reticles 114, 214, or 314 used in deep ultraviolet (DUV) lithography systems, immersion lithography systems, or other lithography systems that use visible light for illumination, as example. Embodiments of the present invention may be implemented to inspect reticles 114, 214, or 314 used in lithography systems, steppers, scanners, step-and-scan exposure tools, or other exposure tools, as examples. The embodiments described herein are implementable to inspect reticles 114, 214, or 314 used in lithography systems that use both refractive and reflective optics and for lenses with high and low numerical apertures (NAs), for example.

Advantages of embodiments of the present invention include providing novel inspection systems 100, 240, and 360 and methods for testing and inspecting lithography reticles 114, 214, or 314. The novel inspection systems 100, 240, 360 may be used to determine if lithography reticles 114, 214, or 314 need to be cleaned or replaced, or to ascertain the effectiveness of cleaning processes used to clean the lithography reticles 114, 214, or 314, for example.

Advantages of other embodiments of the present invention include preventing damage to lithography reticles 114, 214, or 314 by providing one or more devices 116, 246, 248, 316, 346, or 348 adapted to communicate information regarding the distance between the lens system 101, 201, or 301 of the microscope 102, 202, or 302 being used for inspection and the reticle 114, 214, or 314 under inspection, preventing physical contact or impact between the lens system 101, 201, or 301 and the reticle 114, 214, or 314.

Although embodiments of the present invention and their advantages have been described in detail, it should be understood that various changes, substitutions and alterations can be made herein without departing from the spirit and scope of the invention as defined by the appended claims. For example, it will be readily understood by those skilled in the art that many of the features, functions, processes, and materials described herein may be varied while remaining within the scope of the present invention. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. An inspection system, comprising:
a support for a reticle;
a microscope including a lens system and at least one other component; and
at least one device adapted to provide feedback regarding a distance between the support for the reticle and the lens system or the at least one other component of the microscope.

2. The inspection system according to claim 1, wherein the at least one device comprises at least one focus artifact disposed on the support for the reticle.

3. The inspection system according to claim 1, wherein the at least one device comprises at least one sensor disposed on the support for the reticle or proximate the lens system of the microscope.

4. The inspection system according to claim 3, wherein the at least one device comprises at least three sensors disposed on the support for the reticle.

5. The inspection system according to claim 3, wherein the lens system of the microscope comprises a plate and an objective lens coupled to the plate, and wherein the at least one device comprises a sensor coupled to the plate of the microscope proximate the objective lens.

6. An inspection system, comprising:
a support for an extreme ultraviolet (EUV) lithography reticle;
an EUV reticle microscope, the EUV reticle microscope including an EUV light source, a lens system disposed between the EUV light source and the support for the EUV lithography reticle, and an energy collector proximate the lens system; and
at least one focus artifact disposed on the support for the EUV lithography reticle.

7. The inspection system according to claim 6, wherein the at least one focus artifact comprises a first thickness, wherein the EUV lithography reticle comprises a second thickness, and wherein the first thickness is substantially the same as the second thickness.

8. The inspection system according to claim 6, wherein the at least one focus artifact comprises a first thickness, wherein the EUV lithography reticle comprises a second thickness, and wherein the first thickness is less than the second thickness by a predetermined amount.

9. The inspection system according to claim 6, wherein the at least one focus artifact comprises at least one focus pattern disposed thereon and/or at least one region that does not comprise a focus pattern disposed thereon.

10. The inspection system according to claim 9, wherein the at least one focus pattern of the at least one focus artifact comprises the shape of a star, a grating, or a cross.

11. An inspection system, comprising:
a support for an extreme ultraviolet (EUV) lithography reticle;
an EUV reticle microscope, the EUV reticle microscope including a lens system, an EUV light source disposed between the lens system and the support for the EUV lithography reticle, and an energy collector proximate the lens system; and
a plurality of sensors disposed on the support for the EUV lithography reticle or proximate the lens system of the EUV reticle microscope.

12. The inspection system according to claim 11, wherein the plurality of sensors comprises at least three sensors disposed on the support for the EUV lithography reticle, and wherein the plurality of sensors is adapted to provide leveling information regarding the positioning of the support for the EUV lithography reticle with respect to the EUV reticle microscope.

13. The inspection system according to claim 11, wherein the lens system of the EUV reticle microscope comprises a plate and an objective lens coupled to the plate, wherein the plurality of sensors comprises a sensor coupled to the plate of the EUV reticle microscope proximate the objective lens of the lens system, and wherein the sensor coupled to the plate of the microscope is adapted to provide information regarding a distance between the EUV lithography reticle and the objective lens of the EUV reticle microscope.

14. The inspection system according to claim 11, wherein the microscope comprises a reference plate, wherein the at least one sensor is disposed on the reference plate of the microscope, and wherein the sensor coupled to the reference plate of the microscope is adapted to provide information regarding a distance between the EUV lithography reticle and the objective lens of the EUV reticle microscope.

15. The inspection system according to claim 11, wherein the at least one sensor comprises a capacitor sensor or an optical sensor.

16. A method of manufacturing a semiconductor device, the method comprising:
providing an inspection system for a lithography reticle, the inspection system comprising a support for the lithography reticle, the inspection system comprising a microscope comprising an energy source, a lens system disposed between the support for the lithography reticle and the energy source, and an energy collector proximate the lens system, the inspection system further comprising at least one device adapted to provide feedback regarding a distance between the support for the lithography reticle and the lens system of the microscope;
disposing a lithography reticle on the support for the lithography reticle of the inspection system;
inspecting the lithography reticle using the inspection system; and
affecting a semiconductor device using the lithography reticle.

17. The method according to claim 16, wherein providing the inspection system comprises providing an inspection system wherein the at least one device comprises at least one focus artifact disposed on the support for the lithography reticle or at least one sensor disposed on the support for the lithography reticle or proximate the lens system of the microscope.

18. The method according to claim 16, further comprising, after inspecting the lithography reticle using the inspection system: cleaning the lithography reticle; replacing the lithography reticle; altering the lithography reticle; or altering a parameter of a lithography system used to affect the semiconductor device using the lithography reticle.

19. The method according to claim 16, wherein affecting the semiconductor device using the lithography reticle comprises:
providing a workpiece, the workpiece including a material layer to be patterned and a layer of photosensitive material disposed over the material layer; and
patterning the layer of photosensitive material using the lithography reticle.

20. The method according to claim 19, further comprising using the layer of photosensitive material as a mask to pattern the material layer of the workpiece, and removing the layer of photosensitive material.

21. The method according to claim 20, wherein the material layer of the workpiece comprises a conductive material, an insulating material, a semiconductive material, or multiple layers or combinations thereof.

22. A semiconductor device manufactured in accordance with the method of claim 21.

23. An inspection method, comprising:
providing an inspection system for a lithography reticle, the inspection system comprising a support for a lithography reticle, the inspection system comprising a microscope comprising an energy source, a lens system disposed between the support for the lithography reticle and the energy source, and an energy collector proximate the lens system, the inspection system further comprising at least one device adapted to provide feedback regarding a distance between the support for the lithography reticle and the lens system of the microscope;
disposing a lithography reticle on the support for the lithography reticle of the inspection system;
moving the support for the lithography reticle proximate the lens system while obtaining feedback regarding the distance between the support for the lithography reticle and the lens system of the microscope from the at least one device; and
inspecting the lithography reticle using the microscope by illuminating the lithography reticle using the energy source, and analyzing energy collected by the energy collector.

24. The method according to claim 23, wherein the at least one device comprises a plurality of first distance sensors disposed on the support for the lithography reticle and a second distance sensor proximate the lens system, further comprising determining leveling information regarding the support for the lithography reticle relative to the lens system from the plurality of first distance sensors and the second distance sensor while moving the support for the lithography reticle proximate the lens system.

25. The method according to claim 24, further comprising altering the position of the support for the lithography reticle based on the leveling information received from the plurality of first distance sensors and the second distance sensor.

26. The method according to claim 23, wherein the at least one device comprises at least one focus artifact disposed on the support for the lithography reticle, further comprising, before inspecting the lithography reticle using the microscope:
positioning the support for the lithography reticle proximate yet spaced apart from the lens system by a first distance;
moving the support for the lithography reticle to position the focus artifact under an objective lens of the lens system of the inspection system at the first distance;
moving the support for the lithography reticle closer to the lens system, focusing the microscope on the focus artifact at a second distance, the second distance being less than the first distance; and
moving the support for the lithography reticle to position the lithography reticle under the objective lens of the lens system of the inspection system at the second distance.

27. The method according to claim 26, wherein moving the support for the lithography reticle closer to the lens system comprises: first, moving the support for the lithography reticle at a first speed; and second, moving the support for the lithography reticle at a second speed, the first speed being greater than the second speed.

28. The method according to claim 26, wherein focusing the microscope at the first distance or the second distance comprises focusing on a pattern or on a blank region of the focus artifact.
